(19) United States
(12) Patent Application Publication
(10) Pub. No.: US 2008/0258891 A1
(43) Pub. Date: Oct. 23, 2008

(54) DRIVING STATE DISPLAY DEVICE AND STRADDLE TYPE VEHICLE HAVING THE SAME

(75) Inventor: Kazuo Sato, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: Yamaha Motor Electronics Kabushiki Kaisha, Shizuoka-ken (JP)

(21) Appl. No.: 12/106,932

(22) Filed: Apr. 21, 2008

(30) Foreign Application Priority Data
Apr. 20, 2007 (JP) JP2007-111700

(51) Int. Cl. B60Q 1/00

(52) U.S. Cl. 340/439

(57) ABSTRACT

A driving state display device of a straddle type vehicle has a nonvolatile memory in which operation modes are stored to be readable with a grade point provided for each operation mode, the grade point being proportional to a degree of energy-saving operation or uneconomic operation. A microcomputer calculates the rotational speed and acceleration of an engine to determine the operation mode of the vehicle. The grade point corresponding to the operation mode is read from the nonvolatile memory and accumulated until a predetermined time period has elapsed, after which it is determined whether the accumulated value falls in an energy-saving operation range or an uneconomic operation range without the use of a fuel flow meter or the like, said determined result communicated to a rider of the vehicle via a display.

### CROSS-REFERENCE TO RELATED APPLICATIONS

This application is based upon and claims priority under 35 U.S.C. § 119 to Japanese patent application Serial No. 2007-111700, filed Apr. 20, 2007, the entire contents of which is hereby incorporated by reference.

### BACKGROUND OF THE INVENTION

1. Field of the Invention

This invention relates to a driving state display device for a vehicle, and more particularly to a driving state display device for a vehicle that determines whether the vehicle is in an energy-saving operation or in an uneconomic operation and displays said driving state, and to a straddle-type vehicle having the same.

2. Description of the Related Art

The fuel efficiency of a vehicle is a fuel consumption rate of the vehicle, which means a travel distance per a liter of fuel or means how much fuel is consumed to run a predetermined distance. A vehicle exhibits a constant fuel efficiency when running at constant speed on a flat road, and exhibits a mode fuel efficiency in running in a simulated mode of an actual road, including starting and stopping.

Conventional automobiles exist that have a fuel efficiency indicator for displaying fuel efficiency and facilitating a driver making energy-saving operation. The fuel efficiency indicator inputs a vehicle speed signal and an injector signal to a microcomputer as an interrupting signal, counts the number of an internal timer with the interrupting signal, and computes, at a high speed in real time the vehicle speed, a travel distance and a fuel injection amount of the injector to precisely display a real-time fuel efficiency.

If a fuel efficiency indicator for displaying digitally an instant fuel efficiency at intervals of one second is provided, the fuel efficiency is displayed as zero during stopping and is displayed as infinite during running with engine braking. Thus, an operation of an accelerator is directly reflected on the real-time fuel efficiency. Thereby, energy-saving operation and improvement of fuel efficiency can be viewable at once.

Japanese Publication No. JP 2004-93491 discloses displaying a travel distance, fuel costs and fuel efficiency on a display disposed in an instrument panel. However, in this state, the driver cannot determine whether the current driving state is an energy-saving operation with less fuel consumption or an uneconomic operation with more fuel consumption. Also, the driver cannot pursue a safe driving mode by reflecting the driving state such as quick acceleration and quick deceleration.

For example, fuel efficiency improves remarkably during engine braking with no fuel injection. The calculated fuel efficiency also rises when gears are shifted as the engine revolution drops for a moment with less fuel injection while the vehicle speed is almost constant. When the vehicle is waiting, fuel efficiency (consumption) becomes zero as fuel is still consumed for idling while the vehicle does not proceed. However, even if such changes in fuel efficiency are displayed at each change, the driver cannot determine whether or not the driving state was an energy-saving operation as a whole. That is, fuel efficiency relatively varies corresponding to surface conditions of a road, traffic situation, the number of traffic signals and so forth. Accordingly, fuel efficiency rises when running downhill while it drops when running uphill and at quick acceleration. Even if such individual situations are visible on the fuel efficiency indicator, it is still unclear whether or not the driving state is an energy-saving operation as a whole.

Japanese Publication No. JP 2007-22505 discloses that acceleration is calculated based on speed data from a vehicle speed sensor. A degree of acceleration or deceleration during operation is always monitored to grade a running mode and indicate grade points, in which a running of one time is divided into plural sections where the driving state is respectively graded for quick acceleration or quick deceleration and a demerit point is marked for each quick acceleration or quick deceleration in each section. Any fuel unit prices such as gasoline and fuel efficiencies are adapted to be input to display the fuel consumption and fuel costs, and a warning such as a blinking of a display is sent out when inappropriate acceleration or braking is performed.

On the other hand, a display facilitating a driver to pursue energy-saving operation has never been provided on a straddle type vehicle such as a motorcycle.

However, when a driving state display device of JP 2007-22505 is provided with a straddle type vehicle, such as a motorcycle, the driver does not have sufficient time to look at an indicated point to determine whether or not the current driving state is an energy-saving operation because the driver experiences quicker acceleration or deceleration compared to driving an automobile. A warning such as the blinking of a display, which is sent out in case of an appropriate acceleration or braking, can disturb the driver while driving. Therefore, such a warning is not preferable with a straddle type vehicle.

Further, in order to measure fuel efficiency and display a driving state on a straddle type vehicle such as a motorcycle, a fuel flow meter, a load meter or the like is required to be equipped. Accordingly, the cost rises and a space for the measuring equipment is required.

### SUMMARY OF THE INVENTION

In view of the circumstances discussed above, one aspect of the invention is to provide a driving state display device that monitors a driving state to determine whether the driving state is an energy-saving operation or an uneconomic operation without the use of a fuel flow meter, or the like, and that displays the driving state, distinguishing between the energy-saving operation and the uneconomic operation, and to provide a straddle type vehicle having such a driving state display device.

In accordance with one aspect of the present invention, a driving state display device for a vehicle is provided. The driving state display device comprises a nonvolatile memory that stores a plurality of operation modes related to the operation of a straddle type vehicle. The operation modes comprise an idling operation, an accelerated operation, a constant-speed operation, and a decelerated operation. Each operation mode is identified with a grade point proportional to a degree of an energy-saving operation or an uneconomic operation. An operation mode determining module determines the operation mode by inputting a signal related to a rotation of a crankshaft of an engine of the straddle type vehicle to calculate the rotational speed and acceleration of an engine of the vehicle. An adding module repeats at a desired interval a reading of the grade point stored in the nonvolatile memory corresponding to the operation mode determined by the operation mode determining module, the adding module configured to add the grade point at each of the intervals until a predetermined period of time has elapsed to determine an accumulated grade point value. A determining module determines whether the accumulated grade point value calculated by the adding module falls within an energy-saving operation range or and uneconomic operation range. A display displays a signal corresponding to at least one of the energy-saving operation or the uneconomic operation for a given length of time based on the determination made by the determining module.

In accordance with another aspect of the present invention, a driving state display device for a vehicle is provided. The driving state display device comprises a memory that stores a plurality of operation modes related to the operation of a vehicle, each operation mode identified with a grade point associated with a degree of an energy-saving operation or an uneconomic operation. An operation mode determining module determines the operation mode of the vehicle, the operation mode determining module receiving a signal associated with a rotation of a crankshaft of an engine of the vehicle and calculating a rotational speed and an acceleration of an engine of the vehicle. An adding module reads the grade point stored in the memory corresponding to the operation mode determined by the operation mode determining module at a desired interval, the adding module adding the grade point at each of the intervals until a predetermined period of time has elapsed and determining via said addition an accumulated grade point value. A determining module determines whether the accumulated grade point value falls in an energy-saving operation range or and uneconomic operation range without the use of a fuel flow meter. A display device configured to display to a user of the vehicle a signal corresponding to at least one of the energy-saving operation or the uneconomic operation based on the determination made by the determining module.

In accordance with still another aspect of the present invention, a method for operating a driving state display device for a vehicle is provided. The method comprises calculating at least one of a rotational speed and an acceleration of an engine of the vehicle, determining an operation mode of the vehicle based on at least one of said calculated rotational speed and acceleration, reading a grade point corresponding to the determined operation mode at a desired time interval and adding the grade point value to the grade point value read in a previous time interval until a desired time period has elapsed, said added grade point values defining an accumulated value, determining whether the accumulated value corresponds to an energy-saving operation or an uneconomic operation, and displaying a signal corresponding to the operation associated with the accumulated value.

### BRIEF DESCRIPTION OF THE DRAWINGS

These and other features, aspects and advantages of the present inventions will now be described in connection with preferred embodiments, in reference to the accompanying drawings. The illustrated embodiments, however, are merely examples and are not intended to limit the inventions. The drawings include the following 3 figures.

FIG. 1 is a schematic block diagram of a driving state display device according to one embodiment of the present invention.

FIG. 2(a) shows a velocity diagram of a sample operation of a straddle type vehicle.

FIG. 2(b) is a list indicating relationships between grade points of operation modes related to the sample operation in FIG. 2(a), and their frequencies.

FIG. 3 is a flowchart illustrating a control procedure executed by the CPU of a microcomputer.

### DETAILED DESCRIPTION OF THE PREFERRED EMBODIMENTS

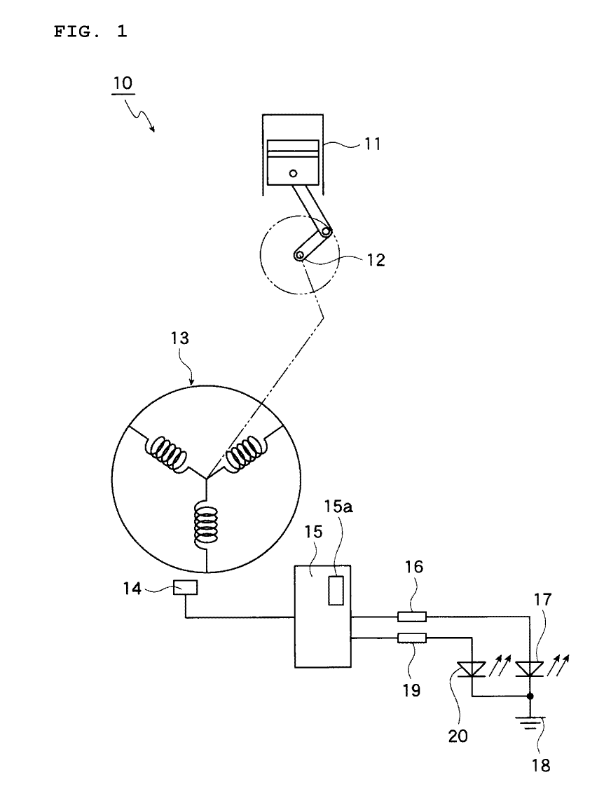

FIG. 1 illustrates a general block diagram showing a driving state display device. Such a driving state display device can be provided on a straddle type vehicle, such as a motorcycle. Additionally, the inventions disclosed herein are not limited to a so-called motorcycle-type two-wheel vehicle, but are applicable to other types of two-wheel vehicles. Furthermore, some aspects of the inventions disclosed herein are not limited to straddle-type vehicles, but can also be used with vehicles with side-by-side seating.

A driving state display device 10 of the straddle type vehicle can receive a rotation period signal of a magneto (e.g., magnetic three-phase alternating-current generator constituting a power generation control system (not shown) of the straddle type vehicle) 13 sensed by a magnetic sensor 14 disposed close to the magneto 13, which can be driven by a crankshaft 12. Said rotation period signal can be input into the driving state display device 10 as a signal related to the rotation of the crankshaft 12 of an engine 11 of the straddle type vehicle. The rotation period signal can be input to an input/output (I/O) port of a microcomputer 15 as an interrupting signal.

The microcomputer 15 can store in a nonvolatile memory 15a, operation modes such as idling, accelerated operation, constant-speed operation, decelerated operation, and the like, wherein the operation modes are related to the operation of the straddle type vehicle so as to be readable with a grade point proportional to a degree of an energy-saving operation or uneconomic operation for each of operation modes.

The nonvolatile memory 15a is not limited to an EEPROM, a flash memory or the like incorporated in the microcomputer 15 but may be an external nonvolatile memory or other suitable storage device. In this embodiment, each of the above operation modes related to the operation of the straddle type vehicle can be stored in the nonvolatile memory 15a to be readable in such a manner that a larger grade point is identified with a mode with a larger degree of uneconomic operation.

The grade point can be marked, for example, in such a manner that the vehicle is first driven at a low constant speed on a driving course which takes about 15 minutes to run through at low constant speed, then the vehicle is driven on the same driving course at a medium constant speed and then driven on the same driving course at a high constant speed. The fuel consumption can be accurately measured each time, and the grade point differentials for the low speed, medium speed and the high speed operation are marked based on differences among the fuel consumptions.

Then, the vehicle is driven at low constant speed with a long period of quick acceleration while the fuel consumption is accurately measured, and thereby the grade point for quick acceleration is marked corresponding to an increase of the fuel consumption. In the same way, the grade points for acceleration, deceleration and quick deceleration are marked. Idling provides the most uneconomic operation because of zero travel distance. However, since a red light forces the vehicle to stop, it is not appropriate to mark a highest grade point on idling.

As one example, operation modes can be classified in descending order of the grade points, the quick accelerated operation=10, the quick decelerated operation=8, the accelerated operation=7, the idling=5, the high constant speed operation=4, the medium constant speed operation=3, the low constant speed operation=2, and the decelerated operation=1. However, the grade points are not static hereto.

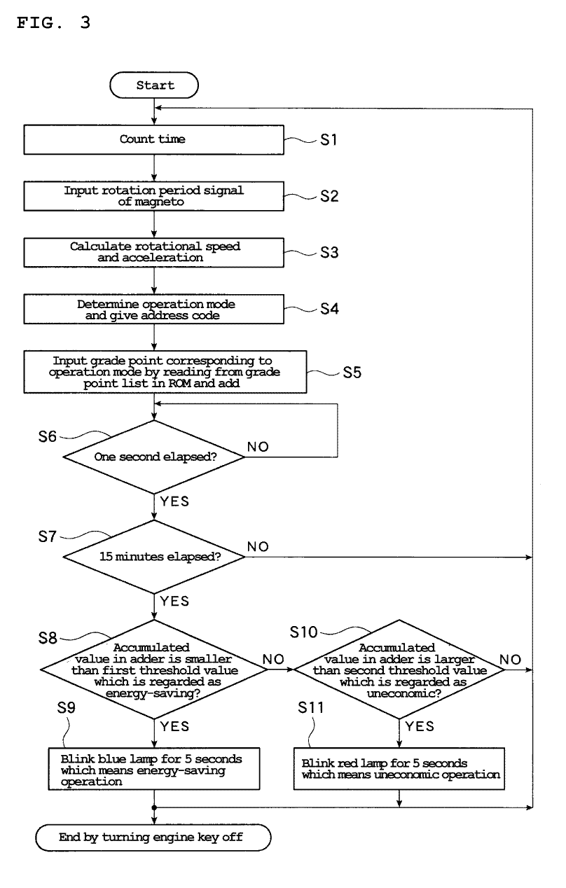

The microcomputer 15 can include an operation mode determining module (e.g., a software subroutine, such as steps S1 to S5 in FIG. 3, which will be described later) for determining an operation mode of the vehicle by inputting a signal related to rotation of the crankshaft 12 of the engine 11 to calculate the rotational speed of the engine 11 and acceleration; an adding module (e.g., software subroutine, such as steps S5 to S7 in FIG. 3) for repeating at close intervals a reading of the grade point stored in the nonvolatile memory 15a corresponding to the operation mode determined by the operation mode determining module and adding the grade point at each of repetition of readings until a predetermined period time has elapsed; a determining module (e.g., a software subroutine, such as steps S8 and S10 in FIG. 3) for determining whether a sum calculated by the adding module belongs to an energy-saving operation or an uneconomic operation; and a displaying module (e.g., a software subroutine, such as steps S9 and S11 in FIG. 3) for displaying that either the energy-saving operation or the uneconomic operation was performed based on the result determined by the determining module for a given length of time.

The microcomputer 15 at, for example, intervals of 5 minutes, can store changes of operation modes in the previous 5 minutes to mark and add a grade point for each change. The microcomputer 15 determines whether or not an operation of the 5 minutes is energy-saving and outputs a display signal when the operation is energy-saving.

For example, the microcomputer 15 can count a rotation period signal input at every second, calculate the rotational speed and the acceleration to determine the operation mode, give a code corresponding to the operation mode, specify an address in the nonvolatile memory by the code, read the grade point stored at the address, and repeat adding a grade point at every second. Further, after a predetermined period of time, 15 minutes for example, the microcomputer 15 can determine whether or not the accumulated sum of the grade points for the 15 minutes is smaller than a grade point (e.g., first threshold value) corresponding to an energy-saving operation. When the accumulated sum of the grade points is smaller, the operation is determined to be energy-saving and a display signal indicating that an energy-saving operation was performed is output. In one embodiment, for example, the microcomputer 15 provides such a display signal by intermittently passing a current for 5 seconds via a resistor 16 to a blue LED 17 and a ground 18.

Further, the microcomputer 15 determines whether the accumulated sum of grade points for the 15 minutes is smaller than the grade point (e.g., first threshold value) corresponding to an energy-saving operation. When the accumulated sum of grade points is determined to be larger, the microcomputer 15 determines whether or not the accumulated sum for the 15 minutes is larger than a grade point (e.g., second threshold value) corresponding to an uneconomic operation. When said accumulated sum of grade points is larger, the operation is determined to be uneconomic, and a display signal indicating that an uneconomic operation was performed is output. In one embodiment, for example, the microcomputer 15 intermittently passes a current for 5 seconds via a resistor 19 to a red LED 20 and the ground 18 to provide such a display signal.

Accordingly, when a rider sees the blue LED 17 blinking, the rider perceives that the operation of the last 15 minutes was energy-saving with less frequent quick accelerations, quick decelerations and/or with a shorter idling times. Similarly, when the rider sees the red LED 19 blinking, the rider perceives that the operation of the last 15 minutes was uneconomic with more frequent quick accelerations, quick decelerations and/or with longer idling times.

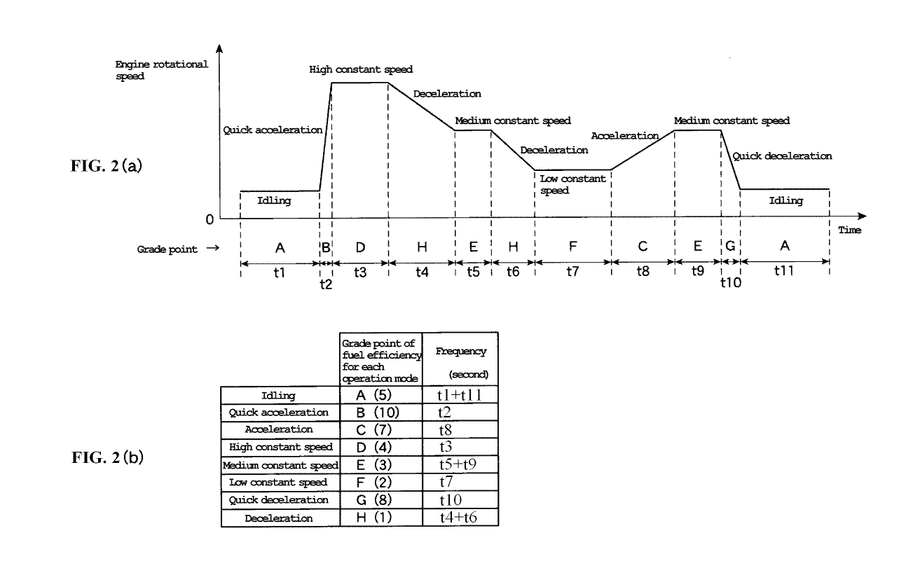

FIG. 2(a) shows a velocity diagram of an operation example of a vehicle, such as a straddle type vehicle (e.g., a motorcycle). With reference to the velocity diagram, the microcomputer 15 adds the grade point per second corresponding to each of the operation modes in this operation example.

In this operation example, the operation mode changes in the following order: idling (for t1 seconds at grade point A); quick acceleration (for t2 seconds at grade point B); high constant speed (for t3 seconds at grade point D); deceleration (for t4 seconds at grade point H); medium constant speed (for t5 seconds at grade point E); deceleration (for t6 seconds at grade point H); low constant speed (for t7 seconds at grade point F); acceleration (for t8 seconds at grade point C); medium constant speed (for t9 seconds at grade point E); quick deceleration (for t10 seconds at grade point G); and idling (for t11 seconds at grade point A).

Accordingly, in this operation example, relationships between the grade points of the operation modes and their frequencies are expressed in a list shown in FIG. 2(b). The microcomputer 15 calculates the accumulated sum of the grade point as: A×t1+B×t2+D×t3+H×t4+E×t5+H×t6+F×t7+C×t8+E×t9+G×t10+A×t11.

When the accumulated sum is smaller than the first threshold value, which can be obtained beforehand (e.g., predetermined) by running a test and stored in the nonvolatile memory 15a, the microcomputer 15 determines that the operation was energy-saving. In contrast, when the accumulated sum is larger than the second threshold value, the microcomputer 15 determines that the operation was uneconomic. Since the operation example shown in FIG. 2(a) has only one episode of quick acceleration, the operation is not necessarily determined uneconomic. The grade point can be graded so that the operation is determined uneconomic when the time period spend in an idling state is large. Also, the grade point can be graded so that the vehicle operation is determined energy-saving when the operation has a short idling time and has neither quick acceleration nor quick deceleration.

FIG. 3 is a flowchart illustrating one embodiment of a control procedure executed by a CPU of the microcomputer 15.

With reference to FIG. 3, when a program starts, at first, the time counting (e.g., via a counter) is started (step S1). Then, the rotation period signal of the magneto 13 sensed by the magnetic sensor 14 is input as an interrupt signal (step S2). A rotational speed and acceleration of the engine 11 are respectively calculated by, for example, counting the rotation period signal (step S3). By verifying the rotational speed and the acceleration of the engine 11 relative to the range of the rotational speed and the range of the acceleration stored in a ROM, the operation mode of the vehicle is specified as one of the quick accelerated operation, the quick decelerated operation, the accelerated operation, idling, the high constant speed operation, the medium constant speed operation, the low constant speed operation, and the decelerated operation. In addition, an address code is given to the operation mode for specifying a memory address of the ROM at which a grade point corresponding to the operation mode is stored (step S4).

Then, in step S5, the memory address of the ROM is specified by the given address code and the grade point stored at the address is read and inputted to an adder to be added.

Then, in step S6, it is determined whether or not a time period (e.g., one second in this flowchart) that is suitable for detecting a degree of acceleration or deceleration, has elapsed since the time counting is started in step S1. In the illustrated embodiment, after one second has elapsed, then, it is determined, for example whether or not an operation elapsed time for determining whether or not the operation is energy-saving (e.g., 15 minutes in the illustrated embodiment) has elapsed since the time counting is started in step S1 (step S7). In another embodiment, the operation elapsed time for determining whether or not the operation is energy saving can be more or less than 15 minutes.

In the illustrated embodiment, in step S7, when it is determined that 15 minutes have not elapsed, steps S1 to S6 described above are repeated. Accordingly, in the illustrated embodiment, steps S1 to S6 described above are repeated at intervals of one second. However, in other embodiments, the time period suitable for detecting a degree of acceleration or deceleration can be more or less than one second. With this process, the grade point read from the ROM is added at every second in the above step S5 until 15 minutes have elapsed.

When it is determined in step S7 that 15 minutes have elapsed, the program proceeds to step S8. In step S8, the accumulated sum of the grade points for the 15 minutes in the adder is compared with the first threshold value regarded as energy-saving, and it is determined whether or not the sum is smaller than this value. When the accumulated sum is smaller than the first threshold value, it is recognized as corresponding to an energy-saving operation.

In step S8, when the sum is determined smaller than the first threshold value, a memorized value of the adder is reset to zero. Then, a current is intermittently passed for 5 seconds via the resistor 16 to the blue LED 17 and the ground 18 (see step S9 and FIG. 1).

Further, in step S8, the accumulated sum is compared with the first threshold value. When it is determined that the sum is larger than the first threshold value, the program proceeds to step S10.

In step S11, the accumulated sum of the grade points for the 15 minutes is compared with the second threshold value regarded as uneconomic operation, and it is determined whether or not the sum is smaller than this value. When the accumulated sum is larger than the second threshold value, it is recognized as corresponding to an uneconomic operation.

In step S10, when the sum is determined larger than the second threshold value, a memorized value of the adder is reset to zero. Then, a current is intermittently passed for 5 seconds via the resistor 19 to the red LED 20 and the ground 18 (see step S111 and FIG. 1).

In step S10, when the sum is determined smaller than the second threshold value, a memorized value of the adder is reset to zero and the program proceeds to the above step S1.

In this flowchart, when the operation of the last 15 minutes is an energy-saving operation, the blue LED 17 is blinked, and when the operation of the last 15 minutes is an uneconomic operation, the red LED 20 is blinked. In a case that the operation is neither an energy-saving operation nor an uneconomic operation, but is normal operation, neither of LEDs is blinked. Though the blue color LED 17 and the red color LED 20 are described in certain embodiments as indicators for indicating an energy saving operation and an uneconomic operation, one of ordinary skill in the art will recognize that other colors can be used. Moreover, the indicators can be any suitable visual indicator and need not be LEDs.

Therefore, when the rider sees the blue LED 17 blinking, the rider knows that the operation was energy-saving and the frequency of quick accelerations and quick decelerations was low during the operation of the last 15 minutes. In contrast, when the rider sees the red LED 20 blinking, the rider knows that the operation was uneconomic and the frequency of quick accelerations and quick decelerations was high during the operation of the last 15 minutes.

According to certain embodiments, operation modes of the straddle type vehicle, such as idling, accelerated operation, constant-speed operation, decelerated operation and the like are registered in a nonvolatile memory with a grade point identified with each operation mode in response to a degree of energy-saving operation. The operation mode can be determined by inputting a signal related to rotation of a crankshaft of an engine to calculate the rotational speed and acceleration of the engine. The grade point corresponding to the determined operation mode registered in the nonvolatile memory (e.g., ROM) is repeatedly read at close intervals and accumulated until a predetermined period of time elapses. A display indicates that an energy-saving operation was performed for the predetermining period of time when the accumulated value is in an energy-saving operation range. Therefore, without the use of a fuel flow meter or the like, the rider can perceive whether driving during a certain period of time including, for example, idling, accelerated operation, constant-speed operation, and decelerated operation was an energy-saving operation or an uneconomic operation. This facilitates the ability of the rider to pursue an energy-saving operation of the vehicle. Thereby, fuel consumption of the straddle type vehicle and exhaust gases can be reduced and the rider's attention to safe driving can be enhanced.

The present invention is not limited to the embodiment described above and has various modifications without departing from the spirit and the technical scope thereof.

For example, in a case that the operation is neither an energy-saving operation nor an uneconomic operation, but is normal operation, both the blue LED 17 and the red LED 20 may be blinked. Or, an orange LED (or other colored indicator) may be provided to be blinked. In one embodiment, a high-intensity LED can b used.

In the embodiment described above, a blinking LED is utilized to notify the rider of both an energy-saving operation and an uneconomic operation. However, in another embodiment, a blinking LED can be employed to notify the rider only for either an energy-saving operation or an uneconomic operation. Further a display device for notifying the rider of a driving state (e.g., energy-saving operation, uneconomic operation) is not limited to a blinking LED.

In another embodiment, the grade point can be set large for constant-speed operation, which is energy-saving; the grade point can be set small for quick accelerated operation, quick decelerated operation and idling, which are uneconomic operations. The operation can be determined to be energy-saving when the accumulated value is larger than the first threshold value, and the operation can be determined to be uneconomic when the accumulated value is smaller than the second threshold value, where the second threshold value is smaller than the first threshold value.

In certain embodiments discussed above, a signal related to the rotation of a crankshaft of an engine of a vehicle (e.g., a straddle type vehicle) is detected from a magneto constituting a power generation control system equipped in the vehicle. The power generation control system, for example, is rotationally driven by a crankshaft of an internal combustion engine and includes a magnetic generator for generating an alternating-current, a generated current regulator for rectifying the alternating-current to direct current and supplying electric devices with a generated current of which generated amount is regulated, and a battery connected (e.g., parallel) with the generated current regulator to the electric devices. The generated current regulator can include a rectifying section and a regulating section, and the regulating section can control the rectifying section and regulate the generated current output from the rectifying section in response to a load current of the electric devices.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. A driving state display device for a vehicle, comprising:
a nonvolatile memory that stores a plurality of operation modes related to the operation of a straddle type vehicle, the operation modes comprising an idling operation, an accelerated operation, a constant-speed operation, and a decelerated operation, each operation mode identified with a grade point proportional to a degree of an energy-saving operation or an uneconomic operation;
an operation mode determining module that determines the operation mode by inputting a signal related to a rotation of a crankshaft of an engine of the straddle type vehicle to calculate the rotational speed and acceleration of an engine of the vehicle;
an adding module that repeats at a desired interval a reading of the grade point stored in the nonvolatile memory corresponding to the operation mode determined by the operation mode determining module, the adding module configured to add the grade point at each of the intervals until a predetermined period of time has elapsed to determine an accumulated grade point value;
a determining module that determines whether the accumulated grade point value calculated by the adding module falls within an energy-saving operation range or and uneconomic operation range; and
a display for displaying a signal corresponding to at least one of the energy-saving operation or the uneconomic operation for a given length of time based on the determination made by the determining module.

2. The driving state display device of claim 1, wherein the display comprises a visual indicator

3. The driving state display device of claim 2, wherein the visual indicator comprises a light emitting diode.

4. The driving state display device of claim 2, wherein the visual indicator comprises two indicators, one indicator actuatable to display a signal corresponding to the energy-saving operation and a second indicator actuatable to display a signal corresponding to the uneconomic operation.

5. The driving state display device of claim 1, wherein said signal related to the rotation of the crankshaft is provided by a magnetic sensor proximate to a magneto, the sensor configured to sense a rotation period of the magneto and to communicate a signal corresponding thereto to a microcomputer

6. The driving state display device of claim 1, wherein the straddle type vehicle is a motorcycle.

7. The driving state display device of claim 1, wherein the nonvolatile memory is part of a microcomputer.

8. A straddle type vehicle characterized by comprising the driving state display device as set forth in claim 1.

9. A driving state display device for a vehicle, comprising:
a memory that stores a plurality of operation modes related to the operation of a vehicle, each operation mode identified with a grade point associated with a degree of an energy-saving operation or an uneconomic operation;
an operation mode determining module that determines the operation mode of the vehicle, the operation mode determining module receiving a signal associated with a rotation of a crankshaft of an engine of the vehicle and calculating a rotational speed and an acceleration of an engine of the vehicle;
an adding module that reads the grade point stored in the memory corresponding to the operation mode determined by the operation mode determining module at a desired interval, the adding module adding the grade point at each of the intervals until a predetermined period of time has elapsed and determining via said addition an accumulated grade point value;
a determining module that determines whether the accumulated grade point value falls in an energy-saving operation range or and uneconomic operation range without the use of a fuel flow meter; and
a display device configured to display to a user of the vehicle a signal corresponding to at least one of the energy-saving operation or the uneconomic operation based on the determination made by the determining module.

10. The driving state display device of claim 9, wherein the plurality of operation modes comprise at least two of an idling operation, an accelerated operation, a constant-speed operation, and a decelerated operation.

11. The driving state display device of claim 9, wherein the display device comprises a visual indicator

12. The driving state display device of claim 11, wherein the visual indicator comprises a light emitting diode.

13. The driving state display device of claim 11, wherein the display device displays a visual signal for a given length of time, said visual signal associated with the energy-saving operation or the uneconomic operation.

14. The driving state display device of claim 9, wherein said signal related to the rotation of the crankshaft is provided by a magnetic sensor proximate to a magneto, the sensor configured to sense a rotation period of the magneto and to communicate a signal corresponding thereto to a microcomputer

15. The driving state display device of claim 9, wherein the memory is a nonvolatile memory.

16. A method for operating a driving state display device for a vehicle, comprising:
calculating at least one of a rotational speed and an acceleration of an engine of the vehicle;
determining an operation mode of the vehicle based on at least one of said calculated rotational speed and acceleration;
reading a grade point corresponding to the determined operation mode at a desired time interval and adding the grade point value to the grade point value read in a previous time interval until a desired time period has elapsed, said added grade point values defining an accumulated value;
determining whether the accumulated value corresponds to an energy-saving operation or an uneconomic operation; and
displaying a signal corresponding to the operation associated with the accumulated value.

17. The method of claim 16, wherein determining whether the accumulated value corresponds to the energy-saving operation comprises determining if the accumulated value is smaller than a first threshold value, and wherein determining whether the accumulated value corresponds to an uneconomic operation comprises determining f the accumulated value is larger than a second threshold value.

18. The method of claim 16, wherein determining an operation mode of the vehicle comprises determining if the operation mode of the vehicle is one of an idling operation, an accelerated operation, a constant-speed operation, and a decelerated operation.

19. The method of claim 16, wherein displaying a signal comprises blinking a light emitting diode of a color corresponding to the energy-saving operation or the uneconomic operation.

20. The method of claim 16, wherein determining whether the accumulated value corresponds to an energy-saving operation or an uneconomic operation is done without the use of a fuel flow meter.
